(19) United States
(12) Patent Application Publication
(10) Pub. No.: US 2025/0178672 A1
(43) Pub. Date: Jun. 5, 2025

(54) VEHICLE FRAME STRUCTURE

(71) Applicant: HONDA MOTOR CO., LTD., Tokyo (JP)

(72) Inventors: Tadashi NAITO, Tokyo (JP); Tomohide SEKIGUCHI, Tokyo (JP); Kanji FUJII, Tokyo (JP); Yoichiro HAMANO, Tokyo (JP); Kenichiro FUKAGAWA, Tokyo (JP); Yoichi MAEDA, Tokyo (JP)

(21) Appl. No.: 18/960,649

(22) Filed: Nov. 26, 2024

(30) Foreign Application Priority Data
Nov. 30, 2023 (JP) 2023-203448

(51) Int. Cl. B62D 25/08; B62D 21/15

(52) U.S. Cl. CPC B62D 25/085; B62D 21/155

(57) ABSTRACT

A first portion of a side frame as a vehicle frame structure includes: paired opposed wall portions extending in a vehicle body front-rear direction; and a coupling wall portion extending in the vehicle body front-rear direction and coupling the paired opposed wall portions to each other, and the coupling wall portion includes a wave plate portion having a wave shape in the vehicle body front-rear direction and a parallel rib formed on the wave plate portion to be parallel to the paired opposed wall portions.

### CROSS-REFERENCE TO RELATED APPLICATION

This application is based upon and claims priority from the Japanese Patent Application No. 2023-203448, filed on Nov. 30, 2023, the entire contents of which are incorporated herein by reference.

### BACKGROUND OF THE INVENTION

### 1. Field of the Invention

The present invention relates to a frame structure of a vehicle.

### 2. Description of the Related Art

In recent years, there is a demand for improving fuel consumption of an automobile from a viewpoint of improving the global environment to suppress natural disasters. Meanwhile, there is a demand for maintaining or improving crash safety of a vehicle. In order to satisfy these demands, a vehicle frame structure that absorbs crash energy is being developed. As such a vehicle frame structure, CN115158479B discloses a front body (engine room) formed of a single die-casting part including multiple ribs.

### SUMMARY OF THE INVENTION

In such a structure, stiffness can be set high. Meanwhile, high stiffness makes the structure less likely to be deformed or crushed, and there is a room for improvement in terms of crash energy absorption. Moreover, in such a structure, there is a risk that, even if the deformation occurs, an uncrushed portion is formed and the structure cannot sufficiently absorb the crash energy.

The present invention is made in view of the abovementioned points, and an object is to provide a vehicle frame structure that can efficiently absorb crash energy and that can also contribute to development of a sustainable transportation system.

In order to achieve the above-mentioned object, the vehicle frame structure of the present invention includes: paired opposed wall portions extending in a vehicle body front-rear direction; and a coupling wall portion extending in the vehicle body front-rear direction and coupling the paired opposed wall portions to each other, and the coupling wall portion includes a wave plate portion having a wave shape in the vehicle body front-rear direction and a parallel rib formed on the wave plate portion to be parallel to the paired opposed wall portions.

According to the present invention, it is possible to efficiently absorb crash energy and also contribute to development of a sustainable transportation system.

### BRIEF DESCRIPTION OF THE DRAWINGS

FIG.1 is a side diagram schematically showing a vehicle body structure to which a vehicle frame structure according to an embodiment of the present invention is applied.

FIG.2 is a perspective diagram schematically showing the vehicle frame structure according to the embodiment of the present invention.

FIG.3 is an end surface diagram along the III-III line in FIG.2.

FIG.4 is a bottom surface diagram (diagram as viewed in the direction of the IV arrow in FIG.2) schematically showing a first portion of the vehicle frame structure according to the embodiment of the present invention.

FIG.5 is a cross-sectional diagram along the V-V line in FIG.2.

FIG.6 is a side diagram (diagram as viewed in the direction of the arrow VI in FIG.2) schematically showing the vehicle frame structure according to the embodiment of the present invention.

### DETAILED DESCRIPTION OF THE EMBODIMENTS

Next, an embodiment of the present invention is explained in detail with reference to the drawings as appropriate by using a case where a vehicle frame structure of the present invention is applied to rear side frames as an example. In the reference drawings, “front-rear” shows a front-rear direction in a traveling direction of a vehicle, “left-right” shows a left-right direction (vehicle width direction) as viewed from a driver seat. Moreover, since the vehicle frame structure is applied to a rear portion of a vehicle body, outward (outer side) in the vehicle body front-rear direction is rearward (rear side), and inward (inner side) in the vehicle body front-rear direction is forward (front side) (opposite in the case where the vehicle frame structure is applied to a front portion of the vehicle body).

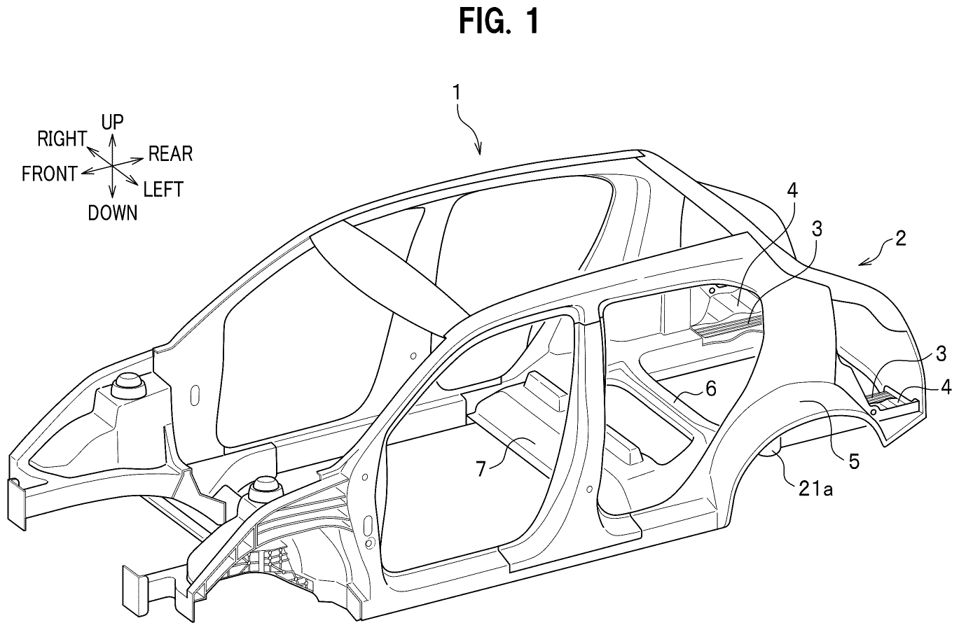

As shown in FIG.1, a vehicle body structure 1 according to the embodiment of the present invention is formed of a die-casting product that is at least partially formed by a die-casting method using aluminum as a material (aluminum die-casting method). The vehicle body structure 1 includes a rear member 2 arranged in the rear portion of the vehicle body.

### Rear Member

The rear member 2 is an example of a vehicle body structure member to which the vehicle frame structure of the present invention is applied, and is a member forming the rear portion in the vehicle body structure 1. The rear member 2 is a die-casting product formed (integrally-molded) by the aluminum die-casting method, and integrally includes side frames 3 paired in the vehicle width direction, panel portions 4, wheel houses 5, and cross members 6 and 7.

### Side Frame (Rear Side Frame)

Each of the side frames 3 is an example of the vehicle frame structure of the present invention, and is a frame that has an open cross-sectional shape and extending in the front-rear direction in a lower portion of the vehicle body on the vehicle width direction end portion side. The side frames 3 are explained in detail later.

### Panel Portions

The panel portions 4 are plate-shaped portions extending in the front-rear direction and the vehicle width direction on the vehicle width direction outer sides of the side frames 3. The panel portions 4 are explained in detail later.

### Wheel Houses

The wheel houses 5 are portions in which wheels (rear wheels in the present embodiment) are housed in spaces formed on the vehicle width direction outer sides of the wheel houses 5. Rear end portions of the wheel houses 5 are connected to front end portions of the panel portions 4. Lower vehicle width direction inner end portions of the wheel houses 5 are connected to upper vehicle width direction outer end portions of the side frames 3.

### Cross Member

The cross member 6 is a frame that has an open cross-sectional shape and that is laid between the side frames 3 and 3 paired in the vehicle width direction between the wheel houses 5 and 5 paired in the vehicle width direction.

### Cross Member

The cross member 7 is a frame that has an open cross-sectional shape and that is laid between the side frames 3 and 3 paired in the vehicle width direction, on the vehicle body front-rear direction inner side (front side in the present embodiment) of the wheel houses paired in the vehicle width direction.

### Side Frame (Rear Side Frame)

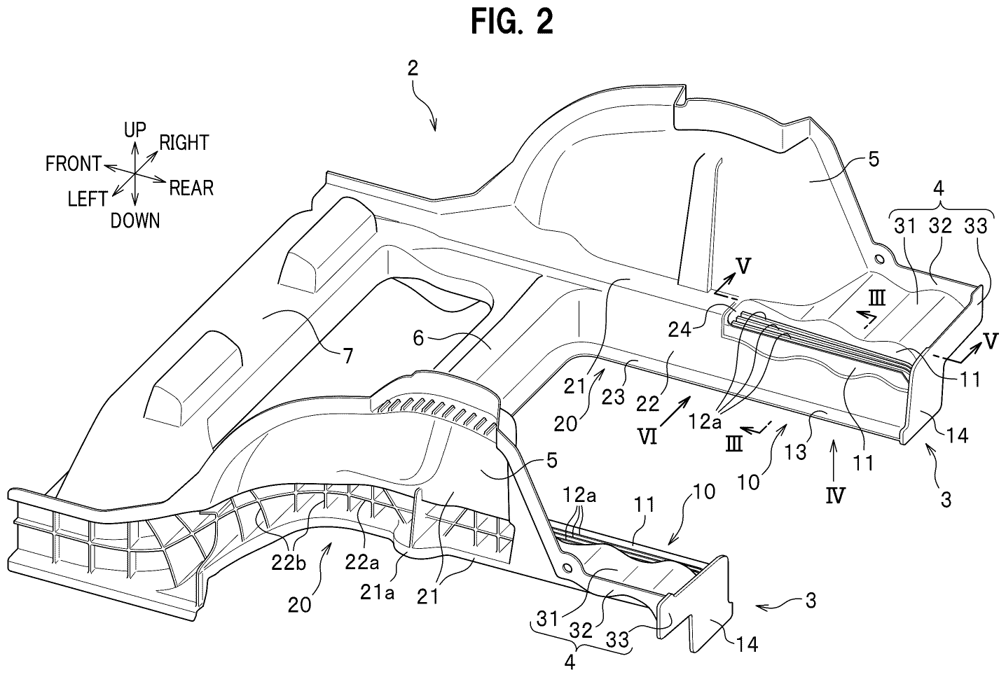

As shown in FIG.2, each of the side frames 3 integrally includes a first portion 10 and a second portion 20 in this order from the rear side toward the front side.

### Side Frame: First Portion

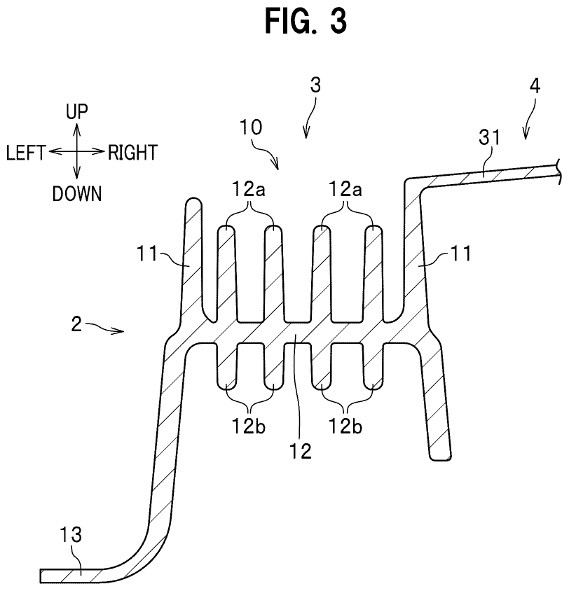

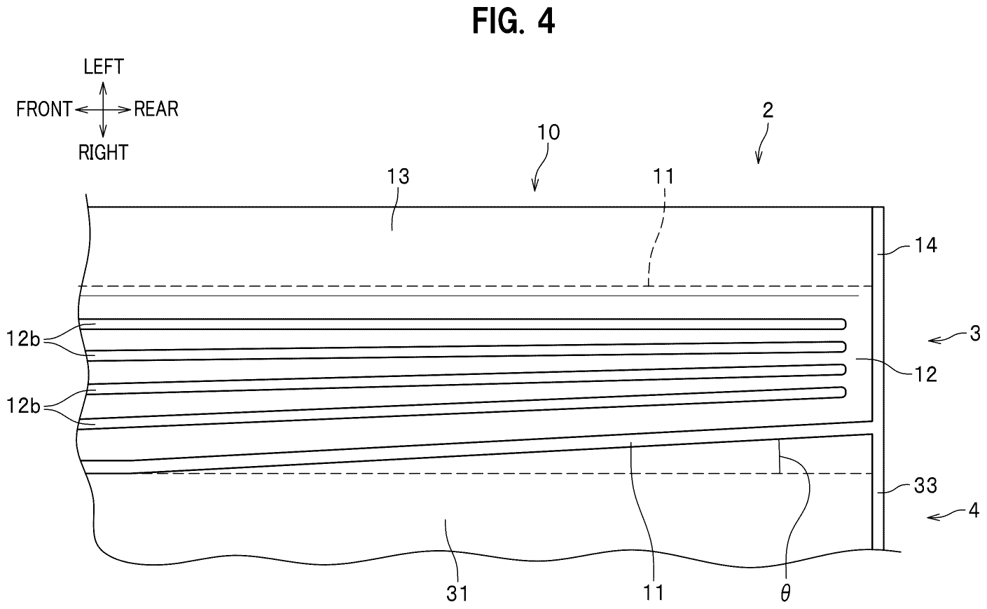

The first portion 10 forms a rear portion of the side frame 3, and includes a portion located on the vehicle width direction inner side of a rear portion of the corresponding wheel house 5 and a portion protruding rearward (outward in the vehicle body front-rear direction. Forward in the case where the side frame is applied to the front portion of the vehicle body) beyond the wheel house 5. As shown in FIG.3, the first portion 10 integrally includes paired opposed wall portions 11 and 11, a coupling wall portion 12 coupling the opposed wall portions 11 and 11 to each other, a flange wall portion 13, and a flat plate portion 14 (see FIG.4).

### Opposed Wall Portions

The opposed wall portions 11 and 11 are long-plate-shaped portions extending in the front-rear direction, and are opposed to each other while being spaced away from each other. In the present embodiment, the opposed wall portions 11 and 11 extend in the front-rear direction and the up-down direction, and are opposed to each other while being spaced away from each other in the vehicle width direction. Specifically, one of the opposed wall portions 11 and 11 is an inner wall portion arranged on the vehicle width direction inner side, and the other one of the opposed wall portions 11 and 11 is an outer wall portion arranged on the vehicle width direction outer side.

As shown in FIG.4, an interval between the paired opposed wall portions 11 and 11 increases toward the front side. In the present embodiment, the opposed wall portion 11 being the outer wall portion is parallel to the front-rear direction of the vehicle. Meanwhile, the opposed wall portion 11 being the inner wall portion tilts inward in the vehicle width direction while extending rearward, and tilts at a tilt angle 0 that is within a range of more than 0° and equal to or less than 5° with respect to the front-rear direction of the vehicle body.

### Gradual Change Portion

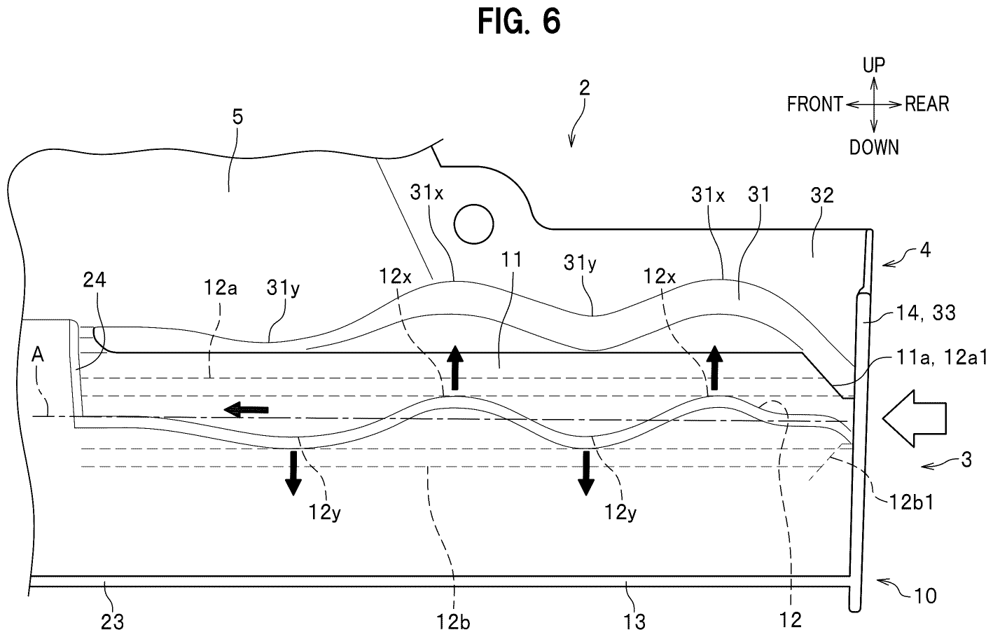

As shown in FIG.6, in an upper portion of the opposed wall portion 11 being the outer wall portion, an outer end portion (rear end portion), in the vehicle body front-rear direction, of the opposed wall portion 11 forms a gradual change portion 11a. The gradual change portion 11a is formed such that a standing height from an amplitude center (oscillation center, center of mountain portions 12x and valley portions 12y in an oscillation direction) A of the coupling wall portion (wave plate portion) 12 decrease toward the outer side in the vehicle body front-rear direction. The standing height of an outer end portion (rear end portion), in the vehicle body front-rear direction, of the gradual change portion 11a from the amplitude center A of the coupling wall portion (wave plate portion) 12 is equal to or smaller than the amplitude of the coupling wall portion (wave plate portion) 12. Specifically, the rear end portion of the gradual change portion 11a is formed such that the height thereof is the same as the height of the mountain portions (peaks) 12x of the coupling wall portion (wave plate portion) 12 or is lower than the mountain portions 12x of the coupling wall portion (wave plate portion) 12. An upper end portion of a portion other than the gradual change portion 11a in the opposed wall portion 11 being the outer wall portion has a linear shape with a uniform height.

Meanwhile, an upper end portion of the opposed wall portion 11 being the inner wall portion has a wave shape identical to a wave plate portion 31 to be described later. Like the opposed wall portion 11 being the outer wall portion, in an upper portion of the opposed wall portion 11 being the inner wall portion, an outer end portion (rear end portion), in the vehicle body front-rear direction, of the opposed wall portion 11 forms the gradual change portion 11a.

### Coupling Wall Portion

As shown in FIG.3, the coupling wall portion 12 is formed to couple the paired opposed wall portions 11 and 11 to each other. In the present embodiment, the coupling wall portion 12 extends in the front-rear direction and the vehicle width direction, and couples intermediate portions of the paired opposed wall portions 11 and 11 in the up-down direction to each other.

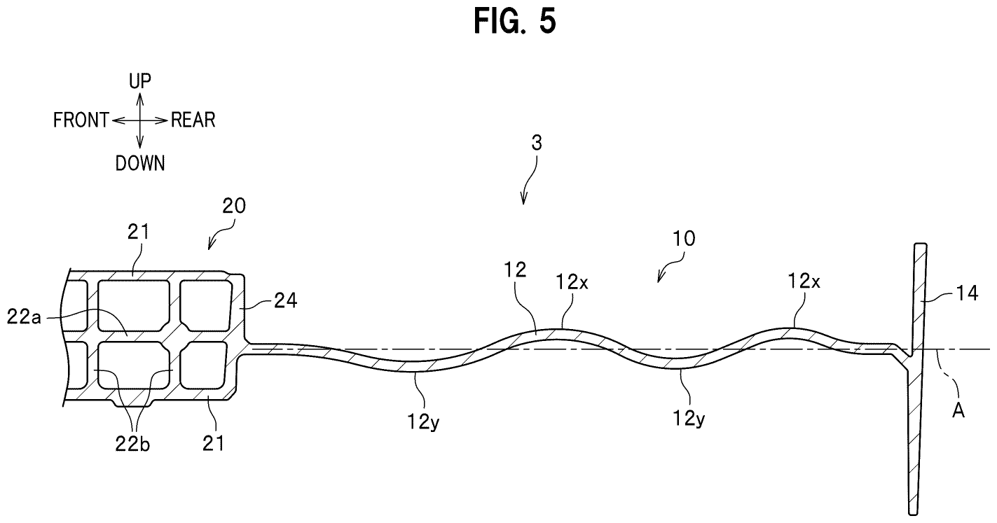

As shown in FIG.5, the coupling wall portion 12 is a wave plate portion having a wave shape in the vehicle body front-rear direction. An outer end portion (rear end portion in the present embodiment), in the vehicle body front-rear direction, of the coupling wall portion 12 comes closer to the amplitude center A while extending outward in the vehicle body front-rear direction, like gradual change portions 12a1 of parallel ribs 12a to be described later.

As shown in FIG.3, multiple parallel ribs 12a and 12b parallel to the opposed wall portions 11 and 11 are formed in the coupling wall portion 12 to be aligned in the vehicle width direction.

### Parallel Ribs

The parallel ribs 12a extend upward from the coupling wall portion 12, and parallel ribs 12b extend downward from the coupling wall portion 12 at the same positions as the parallel ribs 12a in the vehicle width direction. The parallel ribs 12a and 12b extend in the front-rear direction, and are formed parallel to the paired opposed wall portions 11 and 11.

An interval between each two adjacent parallel ribs 12a and 12a increases toward the inner side (front side in the present embodiment) in the vehicle body front-rear direction. Similarly, an interval between each two adjacent parallel ribs 12b and 12b increases toward the inner side (front side in the present embodiment) in the vehicle body front-rear direction (see FIG.4). Specifically, a tilt angle of the parallel ribs 12a and 12b on the vehicle width direction inner side with respect to the vehicle body front-rear direction is larger than a tilt angle of the parallel ribs 12a and 12b on the vehicle width direction outer side with respect to the vehicle body front-rear direction.

### Gradual Change Portion

As shown in FIG.6, an outer end portion (rear end portion), in the vehicle body front-rear direction, of each parallel rib 12a forms the gradual change portion 12a1 . The gradual change portion 12a1 is formed such that the standing height from the amplitude center A of the coupling wall portion (wave plate portion) 12 decreases toward the outer side in the vehicle body front-rear direction. The standing height of the outer end portion (rear end portion), in the vehicle body front-rear direction, of the gradual change portion 12a1 from the amplitude center A of the coupling wall portion (wave plate portion) 12 is equal to or smaller than the amplitude of the coupling wall portion (wave plate portion) 12. Specifically, the rear end portion of the gradual change portion 12a1 is formed to have a height identical to mountain portions (peaks) 12x of the coupling wall portion (wave plate portion) 12 or to be lower than the mountain portions 12x of the coupling wall portion (wave plate portion) 12. In each parallel rib 12a, an upper end portion of a portion other than the gradual change portion 12a1 has a linear shape with a uniform height.

Similarly, an outer end portion (rear end portion), in the vehicle body front-rear direction, of each parallel rib 12b forms a gradual change portion 12b1. The gradual change portion 12b1 is formed such that the standing height from the amplitude center A of the coupling wall portion (wave plate portion) 12 decreases toward the outer side in the vehicle body front-rear direction. The standing height of the outer end portion (rear end portion), in the vehicle body front-rear direction, of the gradual change portion 12b1 from the amplitude center A of the coupling wall portion (wave plate portion) 12 is equal to or smaller than the amplitude of the coupling wall portion (wave plate portion) 12. Specifically, the rear end portion of the gradual change portion 12b1 is formed to have a height identical to valley portions (bottoms) 12y of the coupling wall portion (wave plate portion) 12 or to be higher than the valley portions 12y of the coupling wall portion (wave plate portion) 12. In each parallel rib 12b, an upper end portion of a portion other than the gradual change portion 12b1 has a linear shape with a uniform height.

The gradual change portions 12a1 and 12b1 only need to be formed in at least one of the set of the upper parallel ribs 12a and the set of the lower parallel ribs 12b. Similarly, the gradual change portion 11a only need to be formed in at least one of an upper end portion and a lower end portion of the opposed wall portion 11 (on the same side as the gradual change portions 12a1 and 12b1).

### Flange Wall Portion

The flange wall portion 13 extend inward in the vehicle width direction from the lower end portion of the opposed wall portion 11 being the inner wall portion.

### Flat Plate Portion

As shown in FIG.4, the flat plate portion 14 is a wall portion (rear wall portion) spanning outer end portions (rear end portions in the present embodiment), in the vehicle body front-rear direction, of the paired opposed wall portions 11 and 11, the coupling wall portion 12, and the flange wall portion 13. The flat plate portion 14 is a portion where a bumper (bumper beam) of the vehicle is directly attached or attached via another member.

### Side Frame: Second Portion

As shown in FIG.2, the second portion 20 includes a portion coupled to a lower end portion of a front portion of the wheel house 5 and a portion protruding inward (forward in the present embodiment) in the vehicle body front-rear direction beyond the wheel house 5. The second portion 20 integrally includes paired opposed wall portions 21 and 21, a coupling wall portion 22 that couples the opposed wall portions 21 and 21 to each other, a flange wall portion 23, and a flat plate portion 24.

### Opposed Wall Portions

The opposed wall portions 21 and 21 are long-plate-shaped portions extending in the front-rear direction, and are opposed to each other while being spaced away from each other. In the present embodiment, the opposed wall portions 21 and 21 extend in the front-rear direction and the vehicle width direction, and are opposed to each other while being spaced away from each other in the up-down direction. Specifically, one of the opposed wall portions 21 and 21 is an upper wall portion arranged on the upper side, and the other one of the opposed wall portions 21 and 21 is a lower wall portion arranged on the lower side. Rear end portions of the opposed wall portions 21 are connected to the flat plate portion 24. A vehicle width direction outer end portion of the opposed wall portion 21 being the upper wall portion is connected to a lower end portion of the wheel house 5.

### Coupling Wall Portion

The coupling wall portion 22 is formed to couple the paired opposed wall portions 21 and 21 to each other. In the present embodiment, the coupling wall portion 22 extends in the front-rear direction and the up-down direction, and is an inner wall portion that couples vehicle width direction inner end portions of the paired opposed wall portions 21 and 21 to each other. A rear end portion of the coupling wall portion 22 is connected to a front end portion of the opposed wall portion 11 being the inner wall portion. An upper end portion of the coupling wall portion 22 is connected to the lower end portion of the wheel house 5.

A parallel rib 22a parallel to the opposed wall portions 21 and 21 and multiple spanning ribs 22b laid between the opposed wall portions 21 and 21 are formed on the coupling wall portion 22.

### Parallel Rib

The parallel rib 22a extends outward in the vehicle width direction from an intermediate portion of the coupling wall portion 22 in the up-down direction. The parallel rib 22a extends in the front-rear direction, and is formed to be parallel to the paired opposed wall portions 21 and 21. The parallel rib 22a intersects the multiple spanning ribs 22b. A rear end portion of the parallel rib 22a is connected to the flat plate portion 24.

### Spanning Ribs

The spanning ribs 22b extends outward in the vehicle width direction from the coupling wall portion 22. The spanning ribs 22b are linear ribs linearly extending in a direction intersecting the paired opposed wall portions 21 and 21 (direction orthogonal to the paired opposed wall portions 21 and 21, that is the up-down direction in the present embodiment). Both ends of each spanning rib 22b are connected to the opposed wall portions 21, respectively, and an intermediate portion of the spanning rib 22b intersects the parallel rib 22a.

### Sub-frame Attachment Portion

A sub-frame attachment portion 21a to which a sub-frame (not shown) is attached by bolt fastening or the like is formed in the opposed wall portion 21 being the lower wall portion. The sub-frame is laid between the sub-frame attachment portions 21a and 21a paired in the vehicle width direction.

### Flange Wall Portion

The flange wall portion 23 extend inward in the vehicle width direction from a lower end portion of the coupling wall portion 22. Specifically, the flange wall portion 23 extends inward in the vehicle width direction beyond the coupling wall portion 22 from the vehicle width direction inner end portion of the opposed wall portion 21 being the lower wall portion.

### Flat Plate Portion

The flat plate portion 24 is a wall portion (rear wall portion) spanning end portions (rear end portions in the present embodiment), in the vehicle body front-rear direction, of the paired opposed wall portions 21 and 21 and the coupling wall portion 22.

### Panel Portion

As shown in FIG.2, each panel portion 4 integrally includes the wave plate portion 31, a flange wall portion 32, and a flat plate portion 33.

### Wave Plate Portion

The wave plate portion 31 extends outward in the vehicle width direction from the upper end portion of the opposed wall portion 11 being the outer wall portion. The wave plate portion 31 extends in the front-rear direction and the vehicle width direction, and has a wave shape in the vehicle body front-rear direction. The wave plate portion 31 has a wave shape with the same phase as the wave shape of the coupling wall portion 12, and are arranged at a position above the coupling wall portion 12 in the up-down direction. A rear end portion of the wave plate portion 31 is connected to the flat plate portion 33, and a front end portion of the wave plate portion 31 is connected to the rear end portion of the wheel house 5.

The amplitude of the wave shape of the coupling wall portion 12 and the amplitude of the wave shape of the wave plate portion 31 may be the same or may vary. In the present embodiment, the amplitude of the wave plate portion 31 is larger than the amplitude of the coupling wall portion 12. This configuration can more preferably absorb crash energy than in the case where the amplitude of the wave plate portion 31 and the amplitude of the coupling wall portion 12 are the same, by causing the coupling wall portion 12 and the wave plate portion 31 to be alternately smashed and deformed by being bent.

### Flange Wall Portion

The flange wall portion 32 extend upward from a vehicle width direction outer end portion of the wave plate portion 31. A rear end portion of the flange wall portion 32 is connected to the flat plate portion 33, and a front end portion of the flange wall portion 32 is connected to the rear end portion of the wheel house 5.

### Flat Plate Portion

The flat plate portion 33 is a wall portion spanning end portions (rear end portions in the present embodiment), in the vehicle body front-rear direction, of the wave plate portion 31 and the flange wall portion 32. The flat plate portion 33 is a portion to which the bumper (bumper beam) of the vehicle is directly attached or attached via another member. A vehicle width direction inner end portion of the flat plate portion 33 is connected to a vehicle width direction outer end portion of the flat plate portion 14.

### Transmission of Crash Load in Side Frame and Like

In each side frame 3, the first portion 10 is designed to have lower strength against a rear crash load than the second portion 20. Specifically, in a rear crash of the vehicle, the first portion 10 is preferentially destroyed by the rear crash load (crash load) inputted via the bumper to absorb rear crash energy (crash energy).

As shown in FIG.6, the first portion 10 is smashed and deformed by being bent in the mountain portions 12x of the coupling wall portion 12 with the wave shape such that the mountain portions 12x move upward, and is smashed and deformed by being bent in the valley portions 12y of the coupling wall portion 12 with the wave shape such that the valley portions 12y move downward (see the black arrows). Moreover, the wave plate portion 31 having the wave shape with the same phase as the first portion 10 is smashed and deformed by being bent such that mountain portions 31x move upward in the mountain portions 31x, and is smashed and deformed by being bent such that valley portions 31y move downward in the valley portions 31y, like the first portion 10. The smashing and deformation by bending in the mountain portions 12x and 31a and the valley portions 12y and 31y occurs sequentially in an order from the rear end portion side where the rear crash impact is inputted, toward the front side.

In this case, the interval between each adjacent two of the opposed wall portions 11 and the parallel ribs 12a and 12b increases toward the inner side (front side in the present embodiment) in the vehicle body front-rear direction. Specifically, the strength of the first portion 10 in the side frame 3 decreases from the outer side toward the inner side in the vehicle body front-rear direction. Thus, in the first portion 10, smashing can be made to surely occur in the order from the outer side toward the inner side in the vehicle body front-rear direction such as from portions corresponding to the gradual change portions 11a, 12a1 , and 12b1 to a portion corresponding to the first mountain portion 12x (or the first valley portion 12y) from the rear, then to a portion corresponding to the first valley portion 12y (or the first mountain portion 12x) from the rear, and so on.

In this case, the standing height of each parallel rib 12a from the mountain portions 12x in the mountain portions 12x is smaller than the standing height of each parallel rib 12b from the mountain portions 12x in the mountain portions 12x. Accordingly, the mountain portions 12x in the coupling wall portion 12 are more likely to be smashed and deformed in a bending direction toward the parallel rib 12a side. Moreover, the standing height of each parallel rib 12a from the valley portions 12y in the valley portions 12y is larger than the standing height of each parallel rib 12b from the valley portions 12y in the valley portions 12y. Accordingly, the valley portions 12y in the coupling wall portion 12 are more likely to be smashed and deformed in a bending direction toward the parallel rib 12b side.

Next, a rear crash load whose energy is not absorbed in the first portion 10 is transmitted to the second portion 20. Since the second portion 20 has a higher strength than the first portion 10, the second portion 20 can more preferably transmit the rear crash load to the front of the rear member 2, to a vehicle body structural member with deformation being suppressed.

Specifically, the first portion 10 in each side frame 3 and the rear portions of the panel portion 4 and the wheel house 5 located on the vehicle width direction outer side of the first portion 10 are preferentially smashed and deformed by the rear crash load to absorb the rear crash energy. Meanwhile, since the second portion 20 in the side frame 3 is formed to have higher strength and higher stiffness than the first portion 10, the second portion 20 can preferably transmit the rear crash load and preferably protect peripheral members arranged around the second portion 20.

The vehicle frame structure according to the embodiment of the present invention includes the paired opposed wall portions 11 and 11 that extend in the vehicle body front-rear direction and the coupling wall portion 12 that extends in the vehicle body front-rear direction and that couples the paired opposed wall portions 11 and 11 to each other, the coupling wall portion 12 includes the wave plate portion having the wave shape in the vehicle body front-rear direction, and includes the parallel ribs 12a and 12b formed on the wave plate portion to be parallel to the paired opposed wall portions 11 and 11.

Accordingly, the vehicle frame structure can efficiently absorb the crash energy by causing minor smash to occur multiple times in the mountain portions 12x and the valley portions 12y in the wave shape while generating reaction force against the crash load in the parallel ribs 12a and 12b.

In the vehicle frame structure, at least one of the outer end portions, in the vehicle body front-rear direction, of the opposed wall portions 11 and the parallel ribs 12a and 12b are the gradual change portions 11a, 12a1 , and 12b1 whose standing heights from the amplitude center A of the wave plate portion decrease toward the outer side in the vehicle body front-rear direction.

Accordingly, the vehicle frame structure can cause smashing to preferentially occur in the outer end portion, in the vehicle body front-rear direction, of the frame in crashing of the vehicle, and improve the crash energy absorption efficiency.

In the vehicle frame structure, the outer end portion, in the vehicle body front-rear direction, of the wave plate portion comes closer to the amplitude center A while extending outward in the vehicle body front-rear direction.

Accordingly, in the vehicle frame structure, cooperation of the gradually changing portions and the wave plate portion can preferentially cause smashing in the outer end portion, in the vehicle body front-rear direction, of the frame in crashing of the vehicle, and the crash energy absorption efficiency can be further improved.

In the vehicle frame structure, the standing height of the outer end portion, in the vehicle body front-rear direction, of each gradual change portion from the amplitude center A of the wave plate portion is equal to or smaller than the amplitude of the wave plate portion.

Accordingly, the vehicle frame structure can surely cause the smashing to preferentially occur in the outer end portion, in the vehicle body front-rear direction, of the frame in crashing of the vehicle, and further improve the crash energy absorption efficiency.

In the vehicle frame structure, the parallel ribs 12a and 12b are formed on both surfaces of the wave plate portion.

Accordingly, in the vehicle frame structure, the parallel ribs 12a and 12b on the both surfaces can generate large reaction force (larger than that in the case where the parallel ribs are provided only on one surface) against the crash load. This can achieve a frame with high stiffness and increase an absorption amount of the crash energy.

The vehicle frame structure includes one or more parallel ribs 12a and 12b aligned in the vehicle width direction, and the interval between each adjacent two of the paired opposed wall portions 11 and 11 and the one or more parallel ribs 12a and 12b increases toward the inner side in the vehicle body front-rear direction.

Accordingly, the vehicle frame structure causes smashing to actively occur in a region on the vehicle body front-rear direction outer side where the cross section of the vehicle frame structure is relatively small to suppress smashing in a region on the vehicle body front-rear direction inner side where the cross section is relatively large (suppress smashing at a greater degree than on the vehicle body front-rear direction outer side where the cross section is relatively small). This can protect peripheral members arranged around the region on the vehicle body front-rear direction inner side.

The vehicle frame structure is a rear side frame arranged below and behind the wheel house 5 on the vehicle width direction inner side of the wheel house 5, and includes the sub-frame attachment portion 21a to which the sub-frame is attached, and the wave plate portion is arranged behind the sub-frame attachment portion 21a.

Accordingly, the vehicle frame structure can preferably absorb the crash energy generated by the rear crash load while protecting the sub-frame.

The vehicle frame structure includes the panel portion 4 arranged behind the wheel house 5, the paired opposed wall portions 11 and 11 are aligned in the vehicle width direction, and the panel portion 4 extend outward in the vehicle width direction from the opposed wall portion 11 on the vehicle width direction outer side, and has the wave shape with the phase identical to that of the wave plate portion.

Accordingly, the vehicle frame structure can more preferably absorb the crash energy generated by the rear crash load in a region behind the sub-frame.

The vehicle frame structure includes the flat plate portion 14 spanning the outer end portions, in the vehicle body front-rear direction, of the paired opposed wall portions 11 and 11 and the coupling wall portion 12.

Accordingly, the vehicle frame structure receives the crash load in vehicle crash at the flat plate portion 14, and surely transmits the received impact load to the wave plate portion. The vehicle frame structure can thereby cause sequential smashing of the wave plate portion to surely occur, and surely absorb the crash energy.

The vehicle frame structure is formed by the aluminum die-casting method.

Accordingly, the vehicle frame structure can be improved in the crash energy absorption performance while achieving high recyclability, reduction of CO₂ emission, and high stiffness.

Although the embodiment of the present embodiment has been described above, the present invention is not limited to the above-mentioned embodiment, and can be changed as appropriate within a scope not departing from the spirt of the present invention. For example, the vehicle frame structure of the present invention can be also applied to the front portion of the vehicle body. Moreover, the first portion 10 may be configured such that the paired opposed wall portions 11 are an upper wall portion and a lower wall portion that extend in the front-rear direction and the vehicle width direction, and the coupling wall portion 12 is a side wall that extends in the front-rear direction and the up-down direction.

What is claimed is:

1. A vehicle frame structure comprising:
paired opposed wall portions extending in a vehicle body front-rear direction; and
a coupling wall portion extending in the vehicle body front-rear direction and coupling the paired opposed wall portions to each other, wherein
the coupling wall portion includes
a wave plate portion having a wave shape in the vehicle body front-rear direction, and
a parallel rib formed on the wave plate portion to be parallel to the paired opposed wall portions.

2. The vehicle frame structure according to claim 1, wherein at least one of outer end portions, in the vehicle body front-rear direction, of the opposed wall portions and the parallel rib is a gradual change portion whose standing height from an amplitude center of the wave plate portion decreases toward an outer side in the vehicle body front-rear direction.

3. The vehicle frame structure according to claim 2, wherein an outer end portion, in the vehicle body front-rear direction, of the wave plate portion becomes closer to the amplitude center while extending outward in the vehicle body front-rear direction.

4. The vehicle frame structure according to claim 2, wherein the standing height of an outer end portion, in the vehicle body front-rear direction, of the gradual change portion from the amplitude center of the wave plate portion is equal to or smaller than an amplitude of the wave plate portion.

5. The vehicle frame structure according to claim 1, wherein the parallel rib is formed on both surfaces of the wave plate portion.

6. The vehicle frame structure according to claim 1, wherein
the vehicle frame structure includes one or more of the parallel ribs aligned in a vehicle width direction, and
an interval between each adjacent two of the paired opposed wall portions and the one or more of the parallel ribs increases toward an inner side in the vehicle body front-rear direction.

7. The vehicle frame structure according to claim 1, wherein
the vehicle frame structure is a rear side frame arranged below and behind a wheel house on a vehicle width direction inner side of the wheel house, and includes a sub-frame attachment portion to which a sub-frame is attached, and
the wave plate portion is arranged behind the sub-frame attachment portion.

8. The vehicle frame structure according to claim 7, further comprising a panel portion arranged behind the wheel house, wherein
the paired opposed wall portions are aligned in the vehicle width direction, and
the panel portion extends outward in the vehicle width direction from the opposed wall portion on a vehicle width direction outer side, and has a wave shape with a phase identical to that of the wave plate portion.

9. The vehicle frame structure according to claim 1, further comprising a flat plate portion spanning outer end portions, in the vehicle body front-rear direction, of the paired opposed wall portions and the coupling wall portion.

10. The vehicle frame structure according to claim 1, wherein the vehicle frame structure is formed by an aluminum die-casting method.
